(19) United States
(12) Patent Application Publication
(10) Pub. No.: US 2015/0267934 A1
(43) Pub. Date: Sep. 24, 2015

(54) METHOD OF CONTROLLING CPU AND ELECTRONIC DEVICE THEREOF

(71) Applicant: Samsung Electronics Co., Ltd, Gyeonggi-do (KR)

(72) Inventor: Jin Hui Park, Gyeonggi-do (KR)

(21) Appl. No.: 14/664,571

(22) Filed: Mar. 20, 2015

(30) Foreign Application Priority Data
Mar. 20, 2014 (KR) 10-2014-0033053

(51) Int. Cl. F24F 11/00; G05D 23/19; G05B 15/02

(52) U.S. Cl. CPC F24F 11/0079; G05B 15/02; G05D 23/1917

(57) ABSTRACT

A method of controlling a central processing unit (CPU) includes receiving a user input event; counting a time in response to the reception of the user input event; checking a processing occupancy rate; and restricting processing performance or controlling a rotation speed of a fan.

### CROSS-REFERENCE TO RELATED APPLICATION AND CLAIM OF PRIORITY

The present application is related to and claims priority of Korean patent application No. 10-2014-0033053 filed Mar. 20, 2014, the disclosure of which is hereby incorporated in its entirety by reference, is claimed.

### TECHNICAL FIELD

The present disclosure relates to an electronic device and a method of controlling the CPU performance of the electronic device.

### BACKGROUND

An electronic device includes a main circuit board and many electronic parts that the circuit board includes and performs various operations by mutually transmitting and receiving electrical signals.

With the usage of the electronic device, heat is emitted from the electronic device.

Excessive heat emitted from the electronic device increases ambient temperature and can harm a user who touches the electronic device. Also, excessive heat can destroy the durability of the electronic device. Thus, a technology to decrease heat emission by including one or more fans in the electronic device and controlling the rotation speed of the fans is developed.

The usage of the electronic device as mentioned previously corresponds to the usage of a CPU and when a CPU occupancy rate (utilization rate) is excessively high, heat is heavily emitted, power consumption increases and the processing speed of the CPU decreases.

Also, a technology decreasing heat emission by controlling the rotation speed of a fan is used for maintaining the performance of the electronic device but too high rotation speed of the fan can cause a user to get angry due to noise.

### SUMMARY

To address the above-discussed deficiencies, it is a primary object to provide a method of controlling the CPU performance or the rotation speed of a fan, and an electronic device performing the method in order to overcome the above-described limitations. However, technical issues to be resolved by various embodiments of the present disclosure are not limited to those described above and there be other technical issues.

According to certain embodiments of the present disclosure, a method of controlling a CPU includes receiving a user input event; counting a time in response to the reception of the user input event; checking a CPU occupancy rate; and restricting CPU performance or controlling a rotation speed of a fan.

According to certain embodiments of the present disclosure, an electronic device includes an event reception unit configured to receive a user input event; a processor configured to count a time and check a CPU occupancy rate, in response to the reception of the user input event; and a control unit configured to restrict CPU performance or control a rotation speed of a fan.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments of the present disclosure;

FIG. 2 illustrates an electronic device according to various embodiments of the present disclosure;

FIG. 3 illustrates an exemplary process for restricting CPU performance or the rotation speed of a fan by an electronic device according to various embodiments of the present disclosure;

FIG. 4 illustrates a table representing a CPU temperature and the rotation speed of a fan in a case where a typical electronic device does not restrict CPU performance or the rotation speed of the fan according to various embodiments of the present disclosure;

FIG. 5A illustrates a graph representing a CPU frequency and CPU power consumption before and after the restriction of CPU performance performed by an electronic device according to various embodiments of the present disclosure;

FIG. 5B illustrates a graph representing a CPU frequency and CPU power consumption before and after the control of a rotation speed of a fan performed by an electronic device according to various embodiments of the present disclosure; and

FIG. 6 illustrates an electronic device controlling CPU performance or a rotation speed of a fan according to various embodiments of the present disclosure.

### DETAILED DESCRIPTION

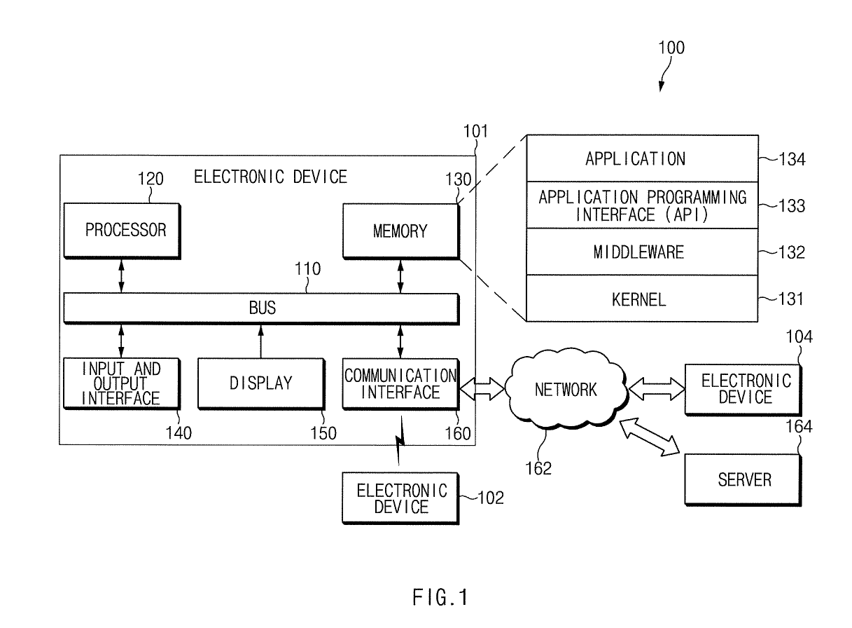

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Various embodiments of the present disclosure are described below in conjunction with the accompanying drawings. Since various embodiments of the present disclosure make various modifications and include many embodiments, particular embodiments will be illustrated in the drawings and related detailed descriptions are disclosed herein. However, the present disclosure is not intended to be limited to particular embodiments and it should be understood that the present disclosure covers all modifications, equivalents, or replacements that fall within the spirit and technical scope of the present disclosure. In describing the drawings, similar components are denoted through the use of similar reference numerals.

The expression “include” or “may include” in various embodiments of the present disclosure indicates the presence of a disclosed corresponding function, operation or component but does not exclude one or more functions, operations or components in addition. Furthermore, it should be understood that the term “includes” or “has” in various embodiments of the present disclosure indicates the presence of characteristics, numbers, steps, operations, components, parts or combinations thereof represented in the present disclosure but do not exclude the presence or addition of one or more other characteristics, numbers, steps, operations, components, parts or combinations thereof.

The expression “or” in the various embodiments of the present disclosure includes any and all combinations of words enumerated together with the expression. For example, the expression “A or B” can include A, B, or both A and B.

The expression “a first,” “a second,” “firstly,” or “secondly” in various embodiments of the present disclosure modifies various components of the present disclosure but do not limit corresponding components. For example, the expressions above do not limit the order or importance of corresponding components. The expressions above are used to distinguish one component from another. For example, a first electronic device and a second electronic device all are electronic devices that are different from each other. In certain embodiments, the first electronic device and the second electronic device are not limited to two electronic devices held by one user but can simply mean two different electronic devices irrespective of a user. Also, without departing from the scope of rights of various embodiments of the present disclosure, a first component can be called a second component and similarly, the second component can also be called the first component.

When any component is referred to as being “connected” or “accessed” to another component, it should be understood that the former can be directly connected to the latter, or there can be another component in between. On the contrary, when it is mentioned that any component is “directly connected” or “directly accessed” to another component, it should be understood that there can be no other component in between.

The terms used in various embodiments of the present disclosure are used only to describe specific embodiments and are not intended to limit the various embodiments of the present disclosure. The terms in singular form include the plural form unless otherwise specified.

Unless otherwise defined herein, all terms used herein including technical or scientific terms have the same meanings as those generally understood by a person skilled in the art to which the various embodiments of the present disclosure pertain. Terms defined in generally used dictionaries should be construed to have meanings matching contextual meanings in the related art and should not be construed as having an ideal or excessively formal meaning unless otherwise defined herein.

An electronic device, according to various embodiments of the present disclosure, is a device that includes a control function for CPU performance or a rotation speed of a fan. For example, the electronic device includes at least one of a smart phone, a smart pad, a tablet personal computer (PC), a mobile phone, a video phone, an e-book reader, a desktop PC, a laptop PC, a net book computer, a personal digital assistant (PDA), a portable multimedia player (PMP), an MP3 player, a mobile medical device, a camera, and a wearable device (such as a head-mounted-device (HMD) such as electronic glasses, electronic clothing, an electronic bracelet, an electronic necklace, an electronic appcessory, or a smart watch).

According to some embodiments, the electronic device is a smart home appliance having the control function. The smart home appliance includes, for example, at least one of a TV, a digital video disk (DVD) player, an audio set, a refrigerator, an air conditioner, a cleaner, an oven, a microwave oven, a washing machine, an air cleaner, a set-top box, a TV box (such as a SAMSUNG HOME SYNC box, APPLE TV box, or GOOGLE TV box), a game console, an electronic dictionary, an electronic key, a camcorder, and an electronic frame.

According to certain embodiments, the electronic device includes at least one of various medical devices (such as a magnetic resonance angiography (MRA) device, a magnetic resonance imaging (MRI) device, a computed tomography (CT) device, a camera, and an ultrasonicator), a navigation system, a global positioning system (GPS) receiver, an event data recorder (EDR), a flight data recorder (FDR), a car infotainment device, electronic equipment for a ship (such as a navigation device or gyro compass for a ship), avionics, or a security device.

According to certain embodiments, the electronic device includes at least one of a portion of a building or structure or furniture including a communication function, an electronic board, an electronic signature receiving device, a projector, and various measurement devices (such as a water, electricity, gas or electric wave measurement device). According to certain embodiments, the electronic device is one or a combination of the above-described various devices. Moreover, it is obvious to a person skilled in the art that electronic devices according to various embodiments are not limited to the above-described devices. In the following, electronic devices according to various embodiments are discussed with reference to the accompanying drawings. The term ‘user’ used in various embodiments indicates a person who uses an electronic device or a device (such as an artificial-intelligence electronic device) that uses the electronic device.

FIG. 1 illustrates a network environment 100 including an electronic device 101 according to various embodiments of the present disclosure.

Referring to FIG. 1, the electronic device 101 includes a bus 110, a processor 120, a memory 130, an input and output interface 140, a display 150, or a communication interface 160.

The bus 110 is a circuit that connects the above-described components mutually and transfers communication (such as a control message) between the above-described components.

The processor 120 receives a command from the above-described components (such as the memory 130, the input and output interface 140, the display 150 or the communication interface 160) through, for example, the bus 110, decrypts a received command and performs calculation or data processing according to a decrypted command.

The memory 130 stores a command or data received from the processor 120 or other components (such as the input and output interface 140, the display 150, or the communication interface 160) or generated by the processor 120 or other components. The memory 130 includes programming modules such as a kernel 131, a middleware 132, an application programming interface (API) 133 or an application 134. Each of the above-described programming modules is configured in software, firmware, hardware or a combination of two or more thereof.

The kernel 131 controls or manages system resources (such as the bus 110, the processor 120 or the memory 130) used for performing an operation or function implemented in other remaining programming modules such as middleware 132, an API 133, or an application 134. Also, the kernel 131 provides an interface that enables the middleware 132, the API 133 or the application 134 to access and control or manage individual components of the electronic device 101.

The middleware 132 functions as an intermediary that enables the API 133 or the application 134 to communicate with the kernel 131 and thus transmit and receive data. Also, in order to process work requests received from applications 134, the middleware 132 uses a method of providing, for example, at least one of the applications 134 with a priority that uses the system resource (such as the bus 110, the processor 120 or the memory 130) of the electronic device 101 to perform load balancing on the work requests.

The API 133 is an interface for enabling the application 134 to control a function provided from the kernel 131 or the middleware 132 and includes at least one interface or function (such as a command) for a file control, a window control, picture processing or a text control.

According to various embodiments, the application 134 includes an SMS/MMS application, an e-mail application, a CPU usage information application, an alarm application or an environment information application (such as an atmosphere or temperature information application). Also, when there is an external electronic device (such as another electronic device 104) communicating with the electronic device 101, the application 134 includes an application related to the information exchange between the electronic device 101 and the external electronic device, for example. For example, the application 134 includes a notification relay application or a device management application that relays information to the external electronic device or manages the external electronic device. The notification relay application includes a function that relays, notification information generated from the electronic device 101, to the external electronic device. For example, the notification relay application includes a function that relays, to the external electronic device, notification information generated through other applications (such as the SMS/MMS application, the e-mail application, the CPU usage information application, the alarm application and the environment information application). Also, the notification relay application receives notification information from the external electronic device. When there is the external electronic device communicating with the electronic device 101, the device management application manages the external device or a service provided from the external electronic device.

For example, the electronic device 101 relays, information such as a CPU occupancy rate of the electronic device 101 or a rotation speed of a fan, to the external electronic device. The external electronic device generates control information capable of controlling the CPU performance or the rotation speed of the fan of the electronic device based on information received from the electronic device 101 and re-transmits the control information to the electronic device 101, and the electronic device controls the CPU performance or the rotation speed of the fan through the device management application based on received control information.

The input and output interface 140 receives a command or data from a user through, for example, an input and output device (such as a sensor, a keyboard or a touch screen) and transfers the command or data to the processor 120, the memory 130 or the communication interface 160 through the bus 110. For example, the input and output interface 140 provides the processor 120 with data on a user touch input through a touch screen. Also, the input and output interface 140 outputs, through the input and out device (such as a speaker or display), the command or data received from the processor 120, the memory 130, or the communication interface 160 through, for example, the bus 110. For example, the input and output interface 140 outputs voice data processed through the processor 120 to a user through the speaker.

The display 150 shows pictures, images or data to the user.

The communication interface 160 connects communication between the electronic device 101 and the electronic device 102, the electronic device 104 or a server 106. The communication interface 160 supports certain short-range communication protocol (such as wireless fidelity (Wi-Fi), Bluetooth (BT), near field communication (NFC)), certain network communication (such as Internet, a local area network (LAN), a wire area network (WAN), a telecommunication network, a cellular network, a satellite network or plain old telephone service (POTS)) 162, or a wired communication protocol (such as a universal serial bus (USB) or high definition multimedia interface (HDMI)). For example, the communication protocol (such as the short-range communication protocol, the network communication protocol, or the wired communication protocol) is supported by at least one of the API 133 or the middleware 132. The electronic device 104 is a device equal to the electronic device 101 (such as of the same type) or different from the electronic device 101 (such as of another type).

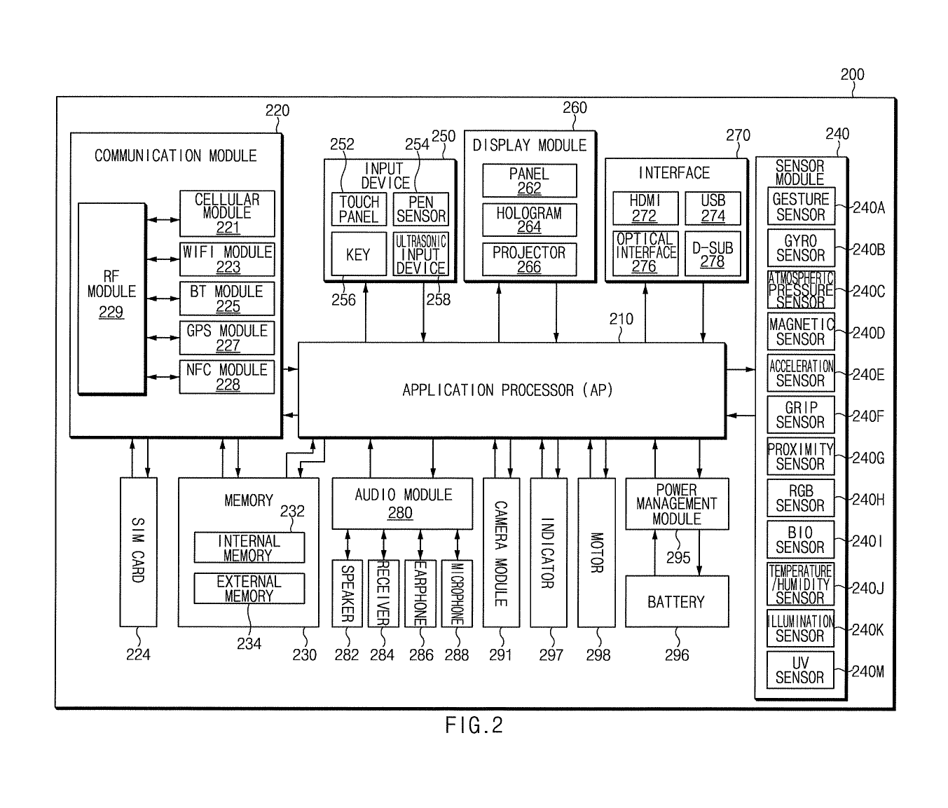

FIG. 2 illustrates a block diagram of an electronic device according to various embodiments of the present disclosure.

The electronic device 200 includes all or some of the electronic device 101 shown in FIG. 1, for example. Referring to FIG. 2, the electronic device 200 includes one or more application processors (APs) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 executes an operating system or application programs to control a plurality of hardware or software components connected to the AP 210 and performs processing and calculation on various pieces of data including multimedia data. The AP 210 is implanted in a system on chip (SoC) for example. According to certain embodiments, the AP 210 further includes a graphic processing unit (GPU) (not shown).

The communication module 220 (such as the communication interface 160) performs data transmission and reception when communication is made between the electronic device 200 (such as the electronic device 101) and other electronic devices (such as the electronic device 104 and the server 106) connected through a network. According to certain embodiments, the communication module 220 includes a cellular module 221, a Wi-Fi module 223, a BT module 225, a GPS module 227, an NFC module 228, and a radio frequency (RF) module 229.

The cellular module 221 provides a voice call, a video call, a message service, or an internet service through a communication network (such as an LTE, LTE-A, CDMA, WCDMA, UMTS, WiBro or GSM network). Also, the cellular module 221 uses, for example, a subscriber identity module (such as a SIM card 224) to perform the identification and authentication of an electronic device in a communication network. According to certain embodiments, the cellular module 221 performs at least some of functions that the AP 210 provides. For example, the cellular module 221 performs at least some of multimedia control functions.

According to certain embodiments, the cellular module 221 includes a communication processor (CP). Also, the cellular module 221 is implemented in an SoC, for example. FIG. 2 shows components such as a cellular module 221 (such as a communication processor), a memory 230 and a power management module 295 separately from the AP 210 but according to certain embodiments, the AP 210 is implemented to include at least some (such as a cellular module 221) of the above-described components.

According to certain embodiments, the AP 210 or the cellular module 221 (such as a communication processor) loads, on volatile memories, commands or data received from at least one of a non-volatile memory connected to thereto or another component, and processes the commands or data. Also, the AP 210 or the cellular module 221 stores, on non-volatile memories, data received from at least one of other components or generated by at least one of other components.

Each of the Wi-Fi module 223, the BT module 225, the GPS module 227 and the NFC module 228 includes a processor for processing data transmitted and received through a corresponding module, for example. FIG. 2 shows each of the cellular module 221, the Wi-Fi module 223, the BT module 225, the GPS module 227, and the NFC module 228 as a separate block, but according to certain embodiments, at least some (such as two or more) of the cellular module 221, the Wi-Fi module 223, the BT module 225, the GPS module 227, and the NFC module 228 are included in one integrated chip (IC) or an IC package. For example, at least some (such as a communication processor corresponding to the cellular module 221 and a Wi-Fi processor corresponding to the Wi-Fi module 223) of processors corresponding to the cellular module 221, the Wi-Fi module 223, the BT module 225, the GPS module 227, and the NFC module 228, respectively be implemented in one SoC.

The RF module 229 performs data transmission and reception, such as transmission and reception of an RF signal. The RF module 229 includes, for example, a transceiver, a power amp module (PAM), a frequency filter or a low noise amplifier (LNA) though not shown. Also, the RF module 229 further includes a part such as a conductor or wire for transmitting and receiving electromagnetic waves in a free space when performing wireless communication. Although FIG. 2 shows that the cellular module 221, the Wi-Fi module 223, the BT module 225, the GPS module 227, and the NFC module 228 share one RF module 229, at least one of the cellular module 221, the Wi-Fi module 223, the BT module 225, the GPS module 227, and the NFC module 228 transmits and receives an RF signal through a separate RF module according to certain embodiments.

The SIM card 224 is a card including a subscriber identification module and is inserted into a slot that is formed on a specific location on an electronic device. The SIM card 224 includes unique identification information (such as an integrated circuit card identifier (ICCID)) or subscriber information (such as an international mobile subscriber identity (IMSI)).

The memory 230 (such as the memory 130) includes an internal memory 232 or an external memory 234. The internal memory 232 includes at least one of, for example, a volatile memory (such as a dynamic RAM (DRAM), a static RAM (SRAM), or a synchronous dynamic RAM (SDRAM)) and a non-volatile memory (such as an one time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to certain embodiments, the internal memory 232 is a solid state drive (SSD). The external memory 234 further includes a flash drive, such as a compact flash (CF) drive, a secure digital (SD) drive, a micro secure digital (micro-SD) drive, a mini secure digital (mini-SD) drive, or an extreme digital (xD) drive, or a memory stick. The external memory 234 is functionally connected to the electronic device 200 through various interfaces. According to certain embodiments, the electronic device 200 further includes a storage device (or storage medium) such as an HDD.

The sensor module 240 measures a physical quantity or sense the operation state of the electronic device 200 to convert measured or sensed information into an electrical signal. The sensor module 240 includes at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (such as a red, green, blue (RGB) sensor), a bio sensor 240I, a temperature/humidity sensor 240J, an illumination sensor 240K or a ultra violet (UV) sensor 240M, for example. The sensor module 240 includes, for example, an E-nose sensor (not shown), an electromyography (EMG) sensor (not shown), an electroencephalogram (EEG) sensor (not shown), an electrocardiogram (ECG) sensor (not shown), an infra-red (IR) sensor (not shown), an iris sensor (not shown) or a fingerprint sensor (not shown). The sensor module 240 further includes a control circuit for controlling at least one sensor that is included in the sensor module 240.

The input device 250 includes a touch panel 252, a (digital) pen sensor 254, a key 256 or an ultrasonic input device 258. The touch panel 252 recognizes a touch input by using at least one of a capacitive, pressure-sensitive, infrared or ultrasonic technique, for example. Also, the touch panel 252 further includes a control circuit. When using a capacitive technique, a physical contact or proximity awareness is possible. The touch panel 252 further includes a tactile layer, which provides a user with a tactile response.

The (digital) pen sensor 254 is implemented by using the same or similar method as that of obtaining a user's touch input or by using a separate sheet for recognition, for example. The key 256 includes, for example, a physical button, an optical key or a keypad. The ultrasonic input device 256 is a device that senses a sound wave with the microphone 288 from the electronic device 200 and checks data, through an input tool generating an ultrasonic signal, and the ultrasonic input device 256 thus perform wireless recognition. According to certain embodiments, the electronic device 200 uses the communication module 220 to receive a user input from an external device (such as a computer or server) connected thereto.

The display 260 (such as a display 150) includes a panel 262, a hologram device 264 or a projector 266. The panel 262 is a liquid-crystal display (LCD) or an active-matrix organic light-emitting diode (AM-OLED), for example. The panel 262 is implemented flexibly, transparently or wearably, for example. The panel 262 also is integrated into the touch panel 252 so that they are implemented in one module. The hologram device 264 uses the interference of a light to show a stereoscopic image in the air. The projector 266 projects a light onto a screen to display an image. The screen is located inside or outside the electronic device 200, for example. According to certain embodiments, the display 260 further includes a control circuit for controlling the panel 262, the hologram device 264 or the projector 266.

The interface 270 includes a high-definition multimedia interface (HDMI) 272, a universal serial bus (USB) 274, an optical interface 276 or a D-subminiature (D-sub) 278, for example. The interface 270 is included in, for example, the communication interface 160 shown in FIG. 1. The interface 270 includes a mobile high-definition link (MHL) interface, an SD card/multi-media card (MMC) interface or an infrared data association (IrDA) interface, for example.

The audio module 280 converts sound into an electrical signal or vice versa. At least some components of the audio module 280 are included in, for example, the input and output interface 140 shown in FIG. 1. The audio module 280 processes sound information input or output through a speaker 282, a receiver 284, an earphone 286 or the microphone 288, for example.

The camera module 291 is a device that captures still pictures and moving pictures, and according to certain embodiments, it is possible to include one or more image sensors (such as a front sensor or rear sensor), lens (not shown), an image signal processor (ISP, not shown), or a flash (not shown) (such as an LED or a xenon lamp).

The power management module 295 manages the power of the electronic device 200. Although not shown, the power management module 295 includes a power management integrated circuit (PMIC), a charger IC, or a battery or fuel gauge, for example.

The PMIC is included in an IC or a SoC semiconductor, for example. Charging techniques is classified into wired and wireless techniques. The charger IC charges the battery and prevents overvoltage or overcurrent from being applied from a charger. According to certain embodiments, the charger IC includes a charger IC for at least one of a wired charging technique and a wireless charging technique. The wireless charging technique includes, for example, a magnetic resonance type, a magnetic induction type, or an electromagnetic wave type, and an additional circuit for wireless charging is added such as a coil loop, a resonance circuit, or a rectifier.

The battery gauge measures the state, current or temperature of the battery 296 or the voltage of the battery 1196 during charging, for example. The battery 296 stores or generates electricity and use stored or generated electricity to supply power to the electronic device 200. The battery 296 includes a rechargeable battery or a solar battery, for example.

The indicator 297 shows the specific states of the electronic device 200 or a portion (such as the AP 210) of the electronic device 200, such as a booting state, a message state or a charged state. The motor 296 converts an electrical signal into mechanical vibration. Although not shown, the electronic device 200 includes a processing device (such as a GPU) for supporting a mobile TV. The processing device for supporting the mobile TV processes media data according to a standard such as digital multimedia broadcasting (DMB), digital video broadcasting (DVB) or media flow.

Each of the above-described elements of hardware according to various embodiments of the present disclosure includes one or more components and the names of corresponding elements vary depending on the category of an electronic device. Hardware according to various embodiments includes at least one of the above-described elements and some elements are left out or other elements are further included. Also, some of the elements of hardware according to various embodiments are combined to form an entity, which equally perform the functions of corresponding elements before being combined.

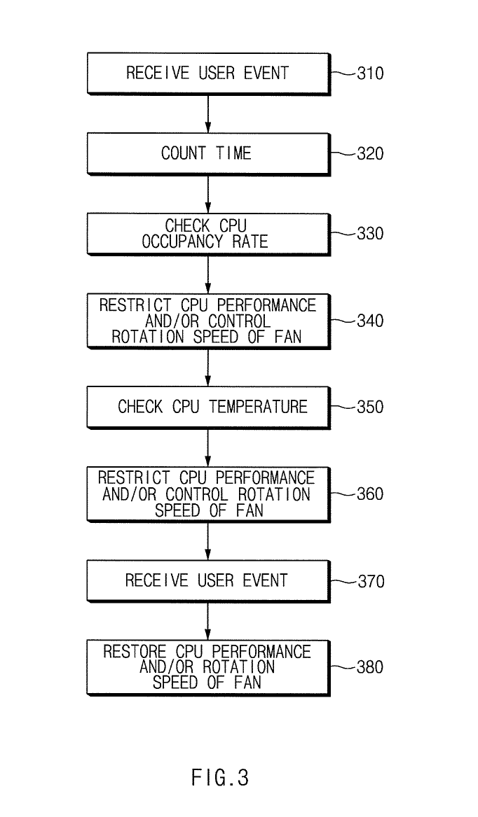

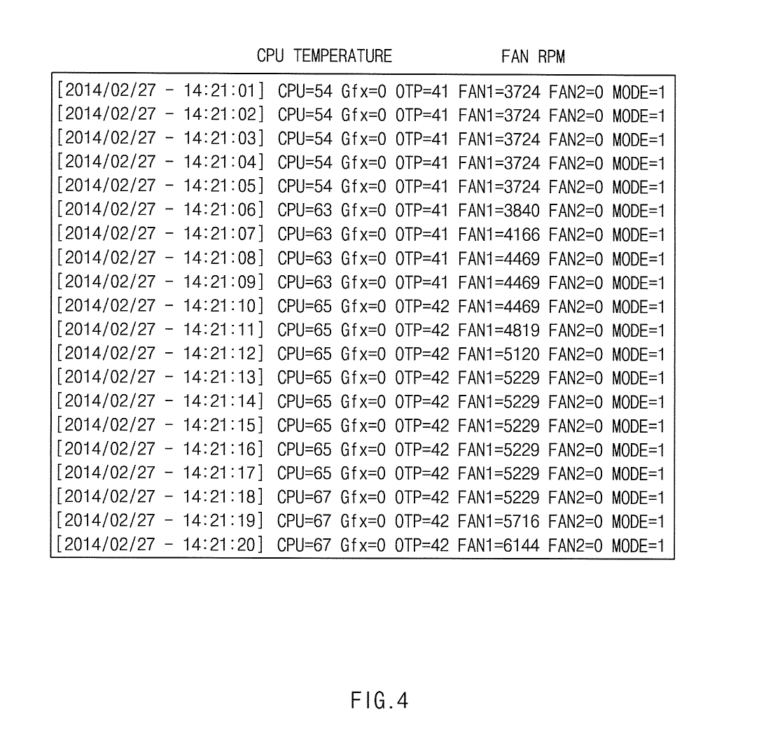

FIG. 3 illustrates an exemplary process for restricting CPU performance or controlling a rotation speed of a fan by an electronic device 101 according to various embodiments of the present disclosure. The method of restricting the CPU performance or controlling the rotation speed of the fan, according to certain embodiments shown in FIG. 3, includes operations that are processed in the time series by the electronic device 101, 200, or 600 according to various embodiments shown in FIGS. 1 and 2 as described above, and FIGS. 4 to 6 to be described below. Thus, the descriptions of the electronic device 101, 200, or 600 of FIGS. 1 to 6 also are applied to the method of restricting the CPU performance or controlling the rotation speed of the fan according to the embodiment shown in FIG. 3 even when the descriptions are left out below. The electronic device 101 is described on behalf of the electronic device 101, 200, or 600 as below.

As mentioned previously, the electronic device 101 is a device including a control function for CPU performance or a rotation speed of a fan, such as a smart phone, a smart pad, a smart home appliance, a medical device, a navigation device, furniture or a portion of a building/structure.

In the following, a desktop, laptop or palmtop PC is provided as an example of the electronic device 101. However, it is noted that the electronic device 101, according to various embodiments of the present disclosure, is not limited to the PC.

In step 310, the electronic device 101 receives a user event corresponding to a user input from a user.

In certain embodiments, the user input is of various types. For example, the user input is an input through the keyboard or mouse of the electronic device 101 or a touch input through a touch panel that the electronic device 101 includes.

In certain embodiments, the touch input means when a finger or a stylus is in physical contact with the panel of the electronic device 101. However, according to a characteristic supported by the panel or the electronic device 101, even while the finger or stylus is not in contact with the panel, a user input according to various embodiments of the present disclosure is detected by the electronic device 101. For example, when the finger is in a certain distance from the panel, the electronic device 101 detects a change in electromagnetic field by the finger, and determines based on a detection result whether the user input is occurred. Similarly, the electronic device 101 determines that a touch input is occurred, when the stylus is close to the panel.

Also, the electronic device 101 determines a signal input from a user through various sensors (sensor module 240 of FIG. 2), as the user input. For example, the electronic device 101 determines a user gesture sensed by the gesture sensor 240A or the proximity sensor 240G of FIG. 2, as the user input.

In step 320, the electronic device 101 counts a time. For example, the electronic device 101 counts the time based on when the user input event is received in operation 310. Thus, it is possible to determine how much time elapses from when the user input event is lastly received.

In step 330, the electronic device 101 checks a CPU occupancy rate. In certain embodiments, the CPU occupancy rate is checked through an operation system (OS) or applications that are executed on the electronic device 101.

Typically, WINDOWS, the OS of MICROSOFT, defines as an idle state when there is no user input for four minutes and the CPU occupancy rate is less than or equal to 80%, and operates background software such as WINDOWS Defender, WINDOWS UPDATE and WINDOWS Search during the idle state. That is, WINDOWS OS determines that a user does not use the electronic device and operates WINDOWS Defender, WINDOWS UPDATE and WINDOWS Search that exert pressure on the operations of a CPU.

Due to the operation of such background software, the CPU occupancy rate is increased and thus heats are emitted. To decrease heat emission, a rotation speed of a fan is increased, but noise also occurs. Also, a user accepts an abnormal situation that heat is heavily emitted and noise occurs even though the user has applied no user input to the electronic device.

For reference, unlike when a storage medium of a typical HDD type is used, enhancement in the processing speed of an SSD overloads CPU when a storage medium of an SSD type is used. Thus, the execution of a plurality of programs scheduled through a task program also overloads the CPU. That is, the CPU experiences a bottleneck situation and a CPU occupancy rate excessively increases.

In step 340, according to various embodiments of the present disclosure, the electronic device 101 restricts CPU performance or control a rotation speed of a fan based on at least one of the CPU occupancy rate according to the operation of the background software, the elapsed time counted in step 320 in order to prevent overload, and the CPU occupancy rate checked in step 330. Also, the restriction of the CPU performance and the control of the rotation speed of the fan also are performed together.

As certain embodiments of the present disclosure, when there is no user input for four minutes and the CPU occupancy rate is less than or equal to 80%, the electronic device 101 restricts CPU performance or reduce a rotation speed of a fan. In certain embodiments, the CPU performance is restricted so that the CPU occupancy rate is less than or equal to 70%.

Furthermore, as certain embodiments of the present disclosure, the electronic device 101 checks on an OS task scheduler that the counted time elapses a preset time and the CPU occupancy rate is less than a preset occupancy rate.

As certain embodiments of the present disclosure, when the electronic device 101 satisfies the condition of an idle state, WINDOWS, the OS of MICROSOFT provides the OS task scheduler with a notice that the electronic device 101 is in a trigger on idle mode.

In certain embodiments, the operations of the restricting CPU performance or controlling the rotation speed of the fan are performed before the entrance into a power saving mode or a screen saver mode. That is, a screen displayed on the screen of the electronic device 101 has no change but CPU performance is internally restricted.

Also, the fan is one or more of at least one fan attached to CPU, at least one fan attached to GPU, and at least one fan attached to the housing of the electronic device 101.

In step 350, the electronic device 101 checks a CPU temperature. According to various embodiments of the present disclosure, the CPU temperature is checked through a CPU usage information application or an environmental info nation application and in certain embodiments, the temperature/humidity sensor 240J of FIG. 2 be used.

In step 360, the electronic device 101 further restricts the CPU performance or further controls the rotation speed of a fan based on the CPU temperature checked in step 350.

In step 370, the electronic device 101 receives a new user input event from the user.

In step 380, the electronic device 101 restores the CPU performance or the rotation speed of the fan in order to prevent an operation corresponding to the new user input event from performing incompletely due to restricted CPU performance.

In certain embodiments, since background software is executing, the electronic device 100 slowly restores the restricted CPU performance or the controlled rotation speed of the fan for a preset time.

The order of steps 310 and 380 described with respect to FIG. 3 is an example and the present disclosure is not limited thereto. That is, the order of the above-described operations varies mutually and some of these operations are performed together. Also, the above-described operations are repeated regularly every preset hours and re-performed based on a user input that is obtained from a user.

FIG. 4 illustrates a table representing CPU temperature and a rotation speed of a fan in a case where a typical electronic device does not restrict CPU performance or the rotation speed of the fan according to various embodiments of the present disclosure.

Times 14:21:01 to 14:21:04 represent the idle state as mentioned previously and background software is performed for the time.

The CPU temperature that has been 54° C. at 14:21:01 has become 67° C. at 14:21:20 with the execution of background software.

Considering that CPU typically maintains 38° C. to 44° C. and the rotation speed of the fan maintains 3000 rpm to 4000 rpm, the CPU is operating under heavy load.

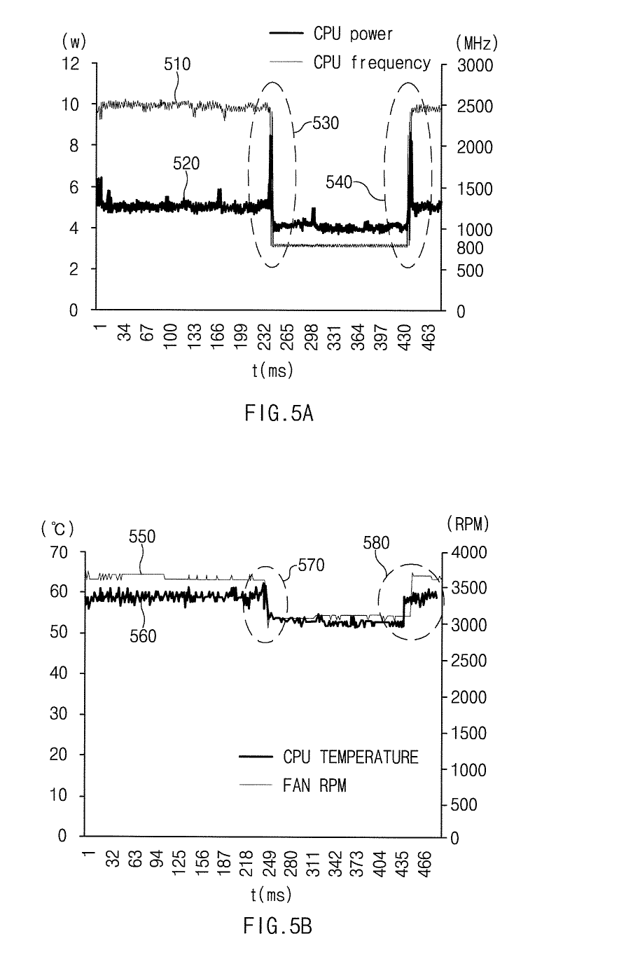

FIG. 5A illustrates a graph representing a CPU frequency and CPU power consumption before and after the restriction of CPU performance performed by the electronic device 101 according to various embodiments of the present disclosure.

Referring to the graph of FIG. 5A, a thin waveform 510 represents a CPU frequency (MHz) and a thick waveform 520 represents CPU power consumption (w).

A region 530 represents when a preset time after the reception of a user input event elapses and a CPU occupancy rate is less than or equal to a preset occupancy rate. The region 530 shows that CPU performance is restricted. Also, a region 540 represents when a new user input event is received and shows that the restricted CPU performance is restored.

Referring to a region 530, due to the restriction of the CPU performance, the CPU frequency decreases from about 2500 MHz to 800 MHz and the CPU power consumption decreases from about 5 w to 4 w.

Referring to a region 540, due to the restoration of the CPU performance, the CPU frequency increases from about 800 MHz to 2500 MHz and the CPU power consumption also increases from about 4 w to 5 w.

FIG. 5B illustrates a graph representing CPU temperature and CPU power consumption before and after the control of a rotation speed of a fan performed by the electronic device 101 according to various embodiments of the present disclosure.

Referring to the graph of FIG. 5B, a thin waveform 550 represents a rotation speed (rpm) of a fan and a thick waveform 560 represents CPU temperature (° C.).

A region 570 represents when a preset time after the reception of a user input event elapses and a CPU occupancy rate is less than or equal to a preset occupancy rate. The region 570 shows that CPU performance is restricted. Also, a region 580 represents when a new user input event is received and shows that the restricted CPU performance is restored.

Referring to the region 570, the rotation speed of the fan decreases from about 3700 rpm to about 3100 rpm and the CPU temperature decreases from about 59° C. to about 53° C.

Referring to the region 580, the rotation speed of the fan increases from about 3100 rpm back to about 3700 rpm and the CPU temperature also increases from about 53° C. to about 59° C.

The graphs of FIGS. 5A and 5B are construed as one. As represented in the regions 530 and 570, when the restriction of the CPU performance and the control of the rotation speed of the fan, the CPU power consumption decreases and the CPU temperature decreases.

The reason that the CPU power consumption decreases in FIG. 5A can be because of the restriction of the CPU performance. According to various embodiments of the present disclosure, the control of the rotation speed of the fan in addition to the restriction of the CPU performance can also be a reason for the decrease of the CPU power consumption. Likewise, one of reasons for the decrease of the CPU temperature can be because of the restriction of the CPU performance in addition to the control of the rotation speed of the fan.

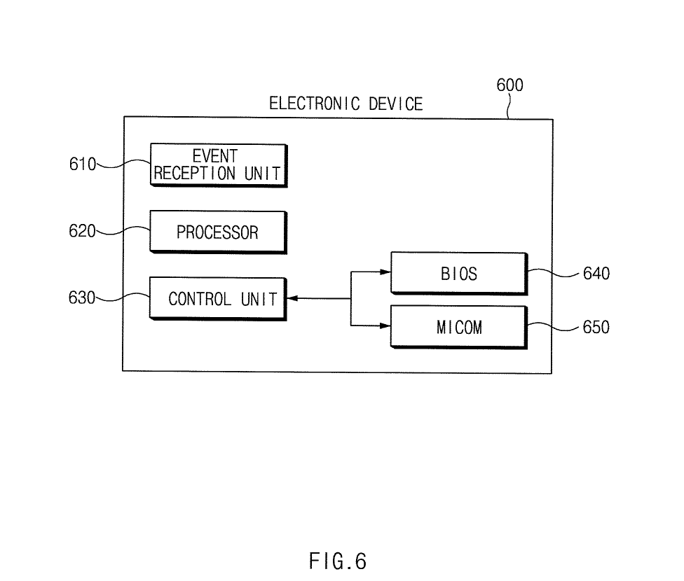

FIG. 6 illustrates an electronic device 600 according to various embodiments of the present disclosure.

Referring to FIG. 6, the electronic device 600 (such as the electronic device 101) includes an event reception unit 610, a processor 620, a control unit 630, a basic input and output system (BIOS) 640, a microcomputer (MICOM) 650 and a memory (not shown). However, the electronic device 600 shown in FIG. 6 is only an implementation of the present disclosure and many variations thereto are performed based on components shown in FIG. 6.

The event reception unit 610 receives a user input event that is generated according to a user input obtained from a user. As discussed previously, the user input is a user input through an input device such as a keyboard, a mouse or a touch pad, a user input by a finger or stylus on the touch panel of the electronic device 600, or a user gesture sensed through various sensors.

The processor 620 counts a time and checks a CPU occupancy rate in response to the reception of the user input event.

For example, the processor 620 regularly transmits polling to a task program operating on an OS (operating system) to check the CPU occupancy rate.

The control unit 630 restricts the CPU performance or controls the rotation speed of the fan. For example, when the time counted by the processor 620 elapses a preset time, the control unit 630 restricts the CPU performance or controls the rotation speed of the fan.

Also, when the CPU occupancy rate checked by the processor 620 is less than a preset occupancy rate, the control unit 630 restricts the CPU performance or control the rotation speed of the fan.

In certain embodiments, when the counted time elapses the preset time and the CPU occupancy rate is less than the preset occupancy rate, the control unit 630 restricts the CPU performance or controls the rotation speed of the fan. Also, the control unit 630 restricts the CPU performance and controls the rotation speed of the fan together.

In particular, the control unit 630 restricts the CPU performance through the control of the BIOS 640. Also, the control unit 630 controls the rotation speed of the fan through the control the MICOM 650.

For example, the control unit 630 generates a control message using a language understandable by the BIOS and the OS and transmits the generated control message to the BIOS 640 or the MICOM 650, and the BIOS 640 or the MICOM 650 analyzes the received control message to restrict the CPU performance or controls the rotation speed of the fan.

In certain embodiments, an example of the language understandable by the BIOS and the OS is the SAMSUNG Advanced BIOS Interface (SABI) of SAMSUNG ELECTRONICS but the present disclosure is not limited thereto and the language varies depending on the manufacturer of the electronic device 600.

An operation performed by one or more of the event reception unit 610, the processor 620, and the control unit 630 as mentioned above are performed by patch software that is installed in the OS.

A memory (not shown) stores data. In certain embodiments, the data stored in the memory includes data that is input and output between components in the electronic device 600. Furthermore, the data stored in the memory includes data that is input and output between the electronic device 600 and components external to the electronic device 600. For example, the memory stores the time counted by or the CPU occupancy rate checked by the processor 620.

As discussed previously, an example of such the memory includes a hard disk drive, a read only memory (ROM), a random access memory (RAM), a flash memory and a memory card that are internal or external to the electronic device 600.

A person skilled in the art will be able to sufficiently understand that the event reception unit 610, the processor 620, the control unit 630, the BIOS 640, the MICOM 650, and the memory (not shown) is separately implemented or one or more thereof is integrated.

A method of controlling a CPU, according to various embodiments of the present disclosure, includes: receiving a user input event; counting a time in response to the reception of the user input event; checking a CPU occupancy rate; and restricting CPU performance or controlling a rotation speed of a fan.

The restricting CPU performance or controlling a rotation speed of a fan, according to various embodiments of the present disclosure, is performed after the counted time elapses a preset time.

The restricting CPU performance or controlling a rotation speed of a fan, according to various embodiments of the present disclosure, is performed when the checked CPU occupancy rate is less than a preset occupancy rate.

The fan, according to various embodiments of the present disclosure, includes at least one of a CPU fan or a GPU fan.

A method of controlling a CPU, according to various embodiments of the present disclosure, further includes checking a CPU temperature.

A method of controlling a CPU, according to various embodiments of the present disclosure, further includes restricting the CPU performance when the checked CPU temperature reaches a preset temperature.

A method of controlling a CPU, according to various embodiments of the present disclosure, further includes after the restricting CPU performance or controlling a rotation speed of a fan, executing background software including an operation system (OS) update.

The restricting CPU performance or controlling a rotation speed of a fan, according to various embodiments of the present disclosure, is performed before activating a power saving mode or a screen saver mode.

A method of controlling a CPU, according to various embodiments of the present disclosure, further includes: receiving a new user input event after the restricting CPU performance or controlling a rotation speed of a fan; and restoring the restricted CPU performance or the controlled rotation speed of the fan.

The restricted CPU performance or the controlled rotation speed of the fan, according to various embodiments of the present disclosure, is restored for a preset time.

An electronic device, according to various embodiments of the present disclosure, includes: an event reception unit configured to receive a user input event; a processor configured to count a time and check a CPU occupancy rate, in response to the reception of the user input event; and a control unit configured to restrict CPU performance or control a rotation speed of a fan.

The restricting of the CPU performance, according to various embodiments of the present disclosure, is performed through a control of a basic input and output system (BIOS).

The controlling of the rotation speed of the fan, according to various embodiments of the present disclosure, is performed through a control of a microcomputer (MICOM).

The restricting of the CPU performance or controlling of the rotation speed of the fan, according to various embodiments of the present disclosure, is performed when the counted time elapses a preset time.

The restricting of the CPU performance or controlling of the rotation speed of the fan, according to various embodiments of the present disclosure, is performed when the checked CPU occupancy rate is less than a preset occupancy rate.

The processor, according to various embodiments of the present disclosure, is further configured to check on an OS task scheduler that the counted time elapses a preset time and the checked CPU occupancy rate is less than a preset occupancy rate.

At least one of various embodiments of the present disclosure restricts the CPU performance of the electronic device or controls the rotation speed of the fan to reduce noise caused by the operation of a fan to manage a CPU usage occupancy rate or to decrease power consumption.

The term “module” used in the present disclosure means a unit including one of hardware, software and firmware or a combination of two or more thereof, for example. The “module” is interchangeably used with the term “unit,” “logic,” “logical block,” “component,” or “circuit,” for example. The “module” is an elementary unit of or a portion of an integral component. The “module” also is an elementary unit for performing one or more functions or a portion of the elementary unit. The “module” is implemented mechanically or electronically. For example, the “module” used in the present disclosure includes at least one of an application-specific integrated circuit (ASIC) chip, a field-programmable gate array (FPGA) and a programmable-logic device that perform some operations and have been known or will be developed.

According to various embodiments, at least some of devices (such as modules or their functions) or methods (such as operations) are implemented as commands stored in a computer-readable storage medium in the form of a programming module, for example. When the command is executed by one or more processors (such as a processor 210), the one or more processors performs a function corresponding to the command. The computer readable storage medium is the memory 220, for example. At least a portion of the programming module is implemented (such as performed) by, for example, the processor 210. At least a portion of the programming module include, for example, a module, program, a routine, a set of instructions or a process for performing one or more functions.

The module or programming module, according to various embodiments of the present disclosure, includes at least one of the above-described elements and some elements be left out or other elements be further included. Operations performed by a programming module or another element, according to various embodiments of the present disclosure, are performed by using a sequential, parallel, repetitive or heuristic method. Also, the execution order of some operations varies, some operations are left out or further operations are added.

The computer readable recording medium includes a magnetic medium such as a hard disk, a floppy disk and a magnetic tape, a magneto-optical medium such as a compact disk read only memory (CD-ROM) and a digital versatile disc (DVD), a magneto-optical media such as a floptical disk, and a hardware device that is especially configured to store and executes a program command (such as a programming module), such as a read only memory (ROM), a random access memory (RAM), and a flash memory. Also, the program command includes a machine code made by a compiler as well as a high-level language code that is executed by a computer by using an interpreter. The above-described hardware device is configured to operate by one or more software modules to perform the operations according to various embodiments of the present disclosure and vice versa.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of controlling a central processing unit (CPU), the method comprising:
receiving a user input event;
counting a time in response to the reception of the user input event;
checking a processing occupancy rate; and
restricting processing performance or controlling a rotation speed of a fan.

2. The method according to claim 1, wherein restricting the processing performance or controlling the rotation speed of the fan is performed after the counted time elapses a preset time.

3. The method according to claim 1, wherein restricting the processing performance or controlling the rotation speed of the fan is performed when the checked processing occupancy rate is less than a preset occupancy rate.

4. The method according to claim 1, wherein the fan includes at least one of a CPU fan or a graphic processing unit (GPU) fan.

5. The method according to claim 1, further comprising:
checking a temperature of the CPU.

6. The method according to claim 5, further comprising:
further restricting the processing performance when the checked temperature reaches a preset temperature.

7. The method according to claim 1, further comprising after restricting the processing performance or controlling the rotation speed of the fan:
executing background software including an operation system (OS) update.

8. The method according to claim 1, wherein restricting the processing performance or controlling the rotation speed of the fan is performed before activating a power saving mode or a screen saver mode.

9. The method according to claim 1, further comprising:
receiving a new user input event after restricting the processing performance or controlling the rotation speed of the fan; and
restoring the restricted processing performance or the controlled rotation speed of the fan.

10. The method according to claim 9, wherein the restricted processing performance or the controlled rotation speed of the fan is restored for a preset time.

11. An electronic device comprising:
an event reception unit configured to receive a user input event;
a processor configured to count a time and check a processing occupancy rate in response to a reception of the user input event; and
a control unit configured to restrict processing performance or control a rotation speed of a fan.

12. The electronic device according to claim 11, wherein to restrict the processing performance is performed through a control of a basic input and output system (BIOS).

13. The electronic device according to claim 11, wherein to control of the rotation speed of the fan is performed through a control of a microcomputer (MICOM).

14. The electronic device according to claim 11, wherein to restrict the processing performance or control the rotation speed of the fan is performed when the counted time elapses a preset time.

15. The electronic device according to claim 11, wherein to restrict the processing performance or control the rotation speed of the fan is performed when the checked processing occupancy rate is less than a preset occupancy rate.

16. The electronic device according to claim 11, wherein the processor is further configured to check on an OS task scheduler when the counted time elapses a preset time and the checked processing occupancy rate is less than a preset occupancy rate.

17. The electronic device according to claim 11, wherein the fan includes at least one of a central processing unit (CPU) fan or a graphic processing unit (GPU) fan.

18. The electronic device according to claim 11, wherein the processor is further configured to:
check a temperature of the CPU.

19. The electronic device according to claim 18, wherein the control unit is configured to:
further restrict the processing performance when the checked temperature reaches a preset temperature.

20. The electronic device according to claim 11, wherein to restrict the processing performance or control the rotation speed of the fan is performed before activating a power saving mode or a screen saver mode.
